(19) United States
(12) Patent Application Publication
(10) Pub. No.: US 2003/0068114 A1
(43) Pub. Date: Apr. 10, 2003

(54) Semiconductor waveguide optical regenerative device

(76) Inventors: Gayle Link, Smyrna, GA (US); Ikechukwu Nnamani, Norcross, GA (US); Gerald Ramdeen, Roswell, GA (US); Sean Jones, Clarkston, GA (US); Calvin Martin, Atlanta, GA (US); Carlos Restrepos, Atlanta, GA (US); Zelda Gills, Atlanta, GA (US); Gary Baker, Atlanta, GA (US); Yancong Shanguan, Duluth, GA (US)

Correspondence Address: Gayle Link, Phd, Suite 930-393, 885 Woodstock Road, Roswell, GA, 30075, US

(21) Appl. No.: 10/211,136

(22) Filed: Aug. 2, 2002

Related U.S. Application Data
(60) Provisional application No. 60/309,742, filed on Aug. 2, 2001.

(51) Int. Cl. G02B 6/12; G02B 6/10

(52) U.S. Cl. 385/14; 385/131

(57) ABSTRACT

An all-optical semiconductor waveguide optical regenerative device uses a nonlinear ridge waveguide structure to mix an input signal with a local oscillator signal to produce wavelength-switched and optically-regenerated signals. The ridge waveguide structure, and the local oscillator sources, filters and amplifiers may be tunable, microprocessor-controlled and monolithically integrated. The present invention relates to semiconductor waveguide-based structures, photonic application-specific integrated circuits, which can be used for optical signal processing and, more particularly wavelength-conversion, wavelength-shifting, wavelength-translation, wavelength-switching, wavelength-routing and optical signal transmission, amplification, pulse-shaping and regeneration in optical networks by integrating multiple functions on monolithic semiconductor substrates of Indium Phosphide and its ternary and quaternary semiconductor material derivatives. The device has been fashioned from InP-InGaAsP material, other non-linear optical bulk or doped materials.

### RELATED APPLICATION

This application claims priority benefit of pending Provisional U.S. Patent Application Ser. No. 60/309,742, filed Aug. 2, 2001, entitled Semiconductor Waveguide Optical Regenerative Device, which applications are hereby incorporated by reference for all purposes.

### BACKGROUND OF THE INVENTION

1. Field of the Invention

The present invention relates to semiconductor waveguide-based structures, photonic application-specific integrated circuits, which can be used for optical signal processing and, more particularly wavelength-conversion, wavelength-shifting, wavelength-translation, wavelength-switching, wavelength-routing and optical signal transmission, amplification, pulse-shaping and regeneration in optical networks by integrating multiple functions on monolithic semiconductor substrates of Indium Phosphide and its ternary and quaternary semiconductor material derivatives.

2. Background

The explosive growth of telecommunications is, to a large degree, both a cause and an effect of the proliferation of fiber optic communication systems. Because of its many advantages, silica optical fiber has now been used in telecommunications for approximately three decades. The advantages include low signal attenuation, immunity to electromagnetic interference (EMI), low crosstalk, fast propagation speed, physical flexibility, small size, and low weight—all at a reasonable cost.

However, other semiconductor materials, like Indium Phosphide have the ability to be used to make even smaller devices that can be passive optic, active optic, hybrid optic (passive-active combinations), or hybrid electro-optic (passive-active-electronic) photonic devices. Passive devices like fiber simply pass or conduct light. Active devices during their operation cause changes to properties or condition of light, including emission, potentially reversing or reducing optical signal degradation or attenuation. Indium Phosphide (InP) is a member of the III-V family of semiconductors. III-V materials are binary crystals with one element from the metallic group 3 of the periodic table, and one from the non-metallic group 5. InP has been a focus of development since the early 1980s, and today the material is being used as a platform for a wide variety of fiber optic communications components, including lasers, (laser diodes and drivers), LEDs, amplifiers, resonators, multiplexer/demultiplexers, semiconductor optical amplifiers, electro-absorption (EA) modulators and photo-detectors. One of the key advantages of InP is device size. Because the refractive indices of InP and its ternary (InGaAs) and quaternary (InGaAsP) derivatives are relatively higher than for other optical materials, bends can be made much sharper and smaller. As the energy bandgap is also closer to light energy, electro-optical effects are stronger in indium phosphide than in other materials. This is essential to shorter waveguide distances, and lower drive voltages. This is one of the major advantages of indium phosphide over lithium niobate, silica and silicon.

In a typical optical network, light modulated with a data signal is coupled to a fiber at a source node, transmitted by a fiber to a destination node, possibly through several intermediate nodes, received at the destination node, demodulated and converted into an electrical data signal. “Light” in the present context includes infrared light; in fact, two of the more commonly used bands are centered around 1550 nanometers and 1310 nanometers, both lying in the near infrared region of the electromagnetic spectrum.

Because of the continuing growth of telecommunication services, service providers need to accommodate ever-higher bandwidths requirements. At this time, bandwidth available on a single wavelength channel (i.e., on a single transmission frequency) is increasing from 2.5 Gbits/s (OC-48/STM-16) to 40 Gbits/s (OC-768/STM-256). These rates, however, are just small fractions of the total bandwidth potentially available from an optical fiber, which is of the order of 20 Terahertz. As the need for more bandwidth exerts its relentless pressure, wavelength division multiplexed (WDM) systems have evolved to wring more carrying capacity from a single fiber. In WDM systems, separate data channels are transmitted through the same fiber on different wavelengths.

As more and more distinct channels are squeezed into a single fiber, narrowband wavelength division multiplexed (NWDM) systems are replaced by dense wavelength division multiplexed (DWDM) systems. But be it few or many, the distinct wavelength channels in a WDM system will need to be processed, (multiplexed/demultiplexed, switched, amplified or regenerated) to improve signal condition, route wavelengths, or to collect the embedded information from the wavelength.

This is particularly true when the information needs to be switched. A common example of a transmission scheme for optical networks is the synchronous optical network/synchronous digital hierarchy (SONET/SDH), a three-layer transport network architecture. In a SONET/SDH network, individual data flows, e.g., tributaries, are mapped into payloads and transported across the network's spans in envelopes, in a synchronous time division multiplexed (TDM) manner. The data flows of a SONET/SDH network must therefore be extracted from the payloads before they can be switched individually.

In a WDM network, the data format and bit rate of each multiplexed wavelength channel can be independent from formats and rates of other channels propagating in the same fiber, because each multiplexed wavelength channel is independent from other channels. For example, one fiber can carry ₁, ₂, and ₃ wavelength channels, where ₁ is a 2.5 Gbit/s SONET OC-48 channel, ₂ is a 10 Gbit/s SONET OC-192 channel, and ₃ is a proprietary format channel. Unlike multiplexed data flows carried by the same wavelength in a SONET/SDH network, each of the three wavelength channels can be optically routed or switched. Ideally the only time such wavelengths should be groomed or decomposed into the electrical bits from the optical light stream is at termination points where the information contained in the optical signal are destined for final delivery. In today's optical networks, these individual wavelengths are typically decomposed at each transmission, switching, add-drop, and regeneration node by transponders. Typically, the majority of the traffic (as high as eighty percent) at each network node is passthrough, or does not require grooming, but it is decomposed anyway via opto-electronic and electro-optic conversions (OEO).

The OEO conversions and resultant electronic digital signal processing typically require arrays of transponders built using electronic microprocessors and integrated circuits. Transponders optically detect signals via a receiver or photodetector and translate the optical signal into electronic digital 1's and O's via framer chipsets. This electronic signal can be demultiplexed and switched electronically. Transponders can then be employed to receive the electronic signal and convert the signal into an optical stream via an electro-optic conversion.

The use of transponders and transponder arrays is expensive. Even more important is that transponders are usually wavelength, format, protocol and bit-rate specific components, requiring a priori knowledge of the wavelength, format, protocol and bit-rate. Switching flexibility is therefore constrained. Moreover, mission critical uptimes require redundancy and inventories of spare transponders. Because transponders are wavelength, format, protocol and bit-rate specific, redundancy becomes costly for each transponder type that has to be stored or provisioned on a one-to-one redundancy, instead of a more affordable N-to-M redundancy with N<M.

In communication networks, optical switches, e.g., optical cross-connects (OXCs), need the ability to separate the multiple wavelength channels carried by one optical fiber, and to multiplex them with other channels for subsequent routing through different optical fibers without interference or contention caused by multiplexing the same wavelength onto a single outbound transmission channel with the same wavelength (or frequency) in use.

Contention becomes more of a problem with the real-time addition and subtraction of wavelengths within a network as the number of network nodes increase, traffic patterns cause changes in network topology and service turn-up (provisioning) times increase. Assume, for example, that a data stream needs to travel from node A to node D, and that a route connecting nodes A and D via nodes B and C exists. Assume further that only wavelength ₁ is available between nodes A and B, and between nodes C and D; and that ₁ is not available between nodes B and C. Another wavelength is needed to make the connection between nodes B and C. The data stream between nodes A and D can first cross the span from node A to node B on the available wavelength ₁. Next, the data stream can be converted (translated or shifted) into ₂, a wavelength available on the span between nodes B and C. The data stream upon arriving at C is then converted back to ₁, the wavelength that is available between nodes C and D. In this way, the previously unavailable route A-B-C-D is made available because of wavelength conversion.

Today transponders are used to perform opto-electronic and electro-optic (OEO) conversions to change or convert wavelengths.

Demultiplexing or switching of optical signals by switches, gratings and interleavers, in the absence of a transponder, do not perform wavelength conversion. Moreover multimode interference (MMI) waveguides, Mach-Zehnder interferometric (MZI) waveguides, and controllable phase shifter schemes which are semiconductor-based devices used for demultiplexing and switching of optical signals as described in U.S. Pat. No. 6,005,992 to Augustsson et al. (the “'992 patent” hereinafter), and U.S. Pat. No. 5,446,809 to Fritz et al. (the “_{'}809 patent”) do not perform wavelength conversion. Thus, the potential for contention is not improved or addressed by these semiconductor-based devices and schemes.

Transponders convert a data flow from one wavelength to another through opto-electronic (OE) conversion and subsequent electro-optic (EO) conversion. (1) OEO-based wavelength-, format-, protocol-, and bit-rate (particularly bit-rate) dependent fixed, (2) OEO-based multi-rate programmable and (3) tunable transponders cannot universally perform N to M wavelength conversions in real-time where the bit-rate of the optical signals to be converted change dynamically and N represents one range of wavelengths (frequencies) and M represents a second range of wavelengths (frequencies). Problems associated with this type of universal conversion stem from the inflexibility and limitations of electronics. Electronic chipsets which control the conversion of modulated optical data are typically not wavelength-dependent. However, they are typically bit-rate, protocol- and format-dependent. Data transmitted optically are encoded at a particular speed such as 2.5 Gb/s or 10 Gb/s. Comparators and phase lock loop approaches are used for low speed transmissions below 2.5 Gb/s to flexibly perform opto-electronic (OE) and electro-optic (EO) conversion. However, comparator or phase lock loops add too much jitter to the signal to be able to perform these conversions dynamically at both 2.5 Gb/s and 10 Gb/s interchangeably. The threshold for these types of solutions is about 6 Gb/s. For a more detailed explanation see the work of F. COPPINGER, ET. AL.,PHOTONIC TIME STRETCH (1999). Thus, two or more separate electronic chipsets or circuits are used to perform the conversions (hence the term multi-rate). Moreover, framing chipsets needed to interpret the 1's and 0's from the modulation scheme will be different if the signal protocol format is IP, SONET, ESCON, etc. Typically different chipsets are used for each type of protocol format. This leaves large numbers of chipset combinations which are needed to flexibly and universally perform opto-electronic and electro-optic conversions on dynamic optical traffic in real-time. This type of limitation and inflexibility adds significant cost and complexity to fiber optic communications networks attempting to obtain the benefits of all-optical signal transparency over wavelength, format, protocol and bit-rate translation via opto-electronic (OE) and electro-optic (EO) conversions.

Thus, it is desirable to achieve wavelength conversion by optical means, avoiding opto-electronic (OE) and electro-optic (EO) conversions. Moreover, many forms of optical wavelength conversion can improve signal to noise ratio, extinction ratio and signal attenuation via the conversion process.

Frequency mixing approaches to optical wavelength conversion such as described in U.S. Pat. No. 5,434,700 to Yoo et al. (the “'700 patent” hereinafter) require large amounts of optical power to create wavelength-shifting or conversion. The conversion ratios, the ratio of output power divided by input power is typically very low.

Semiconductor material based components have been used to perform optical wavelength conversion. A wavelength converter based upon semiconductor optical amplifiers is described in U.S. Pat. No. 6,069,732 to Koch et al. (the “'732 patent” hereinafter). This device is composed of interferometers and semiconductor optical amplifiers. Interferometers such as Michelson's or Mach-Zehnder's are devices which change phase shift differences within two competing optical streams into intensity or amplitude differences. A semiconductor optical amplifier (SOA) is a type of optical signal amplifier which is typically constructed as a waveguide from InP and its quaternary (InGaAsP) or ternaries (InGaAs). SOA's, typically have several problems: high noise figures, cross-talk, and substantial coupling power loss. The gain saturation effect of the optical amplifier is used to achieve wavelength conversion. When the gain of an optical amplifier is changed by one lightwave signal, any signal simultaneously transmitted via the same amplifier also experiences the effect of the gain. U.S. Pat. No. 5,264,960 describes this traveling wave affect and its use to perform wavelength shifting. The device described in '732 patent is a buried heterogenous waveguide structure. A buried structure requires multiple series of epitaxial growths and etches to produce the active or passive “buried” structure. This combination promotes potential handling and misalignment issues during production. Yield rates for such processes averaging thirty percent or less are not uncommon. These issues reduce yield rates and raise the cost of produced devices.

Signal inversion created by the use of semiconductor optical amplifiers and interferometers is described in U.S. Pat. No. 5,978,129 to Jourdan et al. (the “'129 patent” hereinafter). This device uses discrete SOA's which are monitored by a control loop. The control loop measurements from the primary SOA is monitored and compared to a set table of values. When values measured drift from the predetermined optimal values of the table, current injection or negative feedback is applied to the amplifier to restore optimal values. The problem with this approach is that the greatest flexibility of optical signal conversion with high extinction ratio is typically in the control region which produces a negative value for the modulation product, an inverted output signal. Moreover, the control circuitry which introduces frequency response in the range of 5000 Hz to 50,000 Hz does not appear fast enough to produce results to respond to high speed traffic on the order of 10 Gb/s to 44 Gb/s.

Monolithically-integrated structures in which the SOA's and interferometer devices are not distinct units but grown upon the same substrate by series of epitixial growths and etches is described in U.S. Pat. No. 6,005,708 to Leclerc et al. (the “'708 patent” hereinafter). As described earlier, buried structures created by series of epitaxial growths and etches are prone to low yield rates. Moreover, the device is dependent upon the formation of quantum wells in the active layers of the device. While the quantum well approach will produce a less polarization dependent device, however the formation of the quantum wells and the optimization of the density of quantum wells exacerbate the manufacturing process with additional etching processes. The problem with inversion of the optical signal and breath of conversion capability and utility is still not answered.

Another integrated device is described in U.S. Pat. No. 6,035,078 to Dagens et al. (the “'078 patent” hereinafter). This device consists of at least one amplifier branch which is less than 300 μm. While this restriction is sufficient to prevent extinction ratio degradation for low speed wavelength conversion, it promotes pattern dependence and a slower wavelength converter performance for high-speed conversions, conversions higher than 8 Gb/s.

A need therefore exists for an optical wavelength conversion device which can provide fast, flexible conversion over a wide range of wavelengths, that does not invert the optical signal, does not degrade the extinction ratio or be susceptible to pattern dependence at high bit-rates.

### SUMMARY OF THE INVENTION

The present invention relates to semiconductor waveguide-based structures, photonic application-specific integrated circuits, which can be used for optical signal processing and, more particularly wavelength-conversion, wavelength-shifting, wavelength-translation, wavelength-switching, wavelength-routing and optical signal transmission, amplification, pulse-shaping and regeneration in optical networks by integrating multiple functions on monolithic semiconductor substrates of Indium Phosphide and its ternary and quaternary semiconductor material derivatives.

The structure consists of a mode squeezing passive to active port leading into and exiting out of the wavelength resonator cavity. The cavity is bi-directional to allow for pump signal to transmit in a co-propagating or counter-propagating manner with the input signal. The cavity is designed to detect differences in the intensity of a modulated signal entering into the cavity. The detection of the differences within the intensity creates carrier inversion and carrier mobility within the material structure. The carrier inversion simultaneous modulates the index of refraction within the cavity. Thus, additional waves, such as the pump wavelength traveling simultaneously through the cavity will become modulated in phase. The interferometric waveguides leading from the cavity convert the phase modulation into intensity modulation. Thus, the pump wavelength is now modulated with the modulation scheme similar to the input wavelength. Because of optimal operating conditions, conditions which provide the largest bandwidth conversion and extinction ratio typically invert the signal. Thus, a second interferometric cavity is needed. The second cavity not only corrects for the inversion, but also further improves the signal extinction ratio and signal noise improvement.

This semiconductor waveguide optical regenerative device, photonic application specific integrated circuit, may additionally include one or more of the following: an amplifier, such as active fiber and optical pump combination, for amplifying the input or output signals; local oscillator sources for generating the local oscillator signals; monitors for obtaining data relating to the input signal and to the output signals; thermocouple, thermistor and/or thermoelectric cooler for maintain temperature of semiconductor structure; lensed fiber to facilitate light reception and exiting the converter and a computer for receiving the signal data and tuning the filters, the optical pump, the local oscillator sources, and the quasi-phasematching structure.

In some embodiments, the structure may be described as a monolithically integrated structure or array of structures, but the device can also be produced from discrete integrated components.

### BRIEF DESCRIPTION OF THE DRAWINGS

The present invention will now be explained, by way of examples only, with reference to the following description, appended claims, and accompanying figures where:

FIG. 1a is a schematic diagram of an embodiment of a semiconductor waveguide optical regenerative device used in counter-propagating wavelength transmission;

FIG. 1b is a schematic diagram of a semiconductor waveguide optical regenerative device used in co-propagating wavelength transmission;

FIG. 2a is a schematic diagram of a semiconductor waveguide optical regenerative device with mode-squeezing passive-active waveguide ports;

FIG. 2b is a schematic diagram of a two-dimensional cut away of the semiconductor waveguide optical regenerative device with mode-squeezing passive-active waveguide ports;

FIG. 3a is a schematic diagram schematic diagram of the ridge waveguide resonator cavity of the semiconductor waveguide optical regenerative device;

FIG. 3b is a schematic diagram schematic diagram of a two-dimensional cut away of the of the ridge waveguide resonator cavity of the semiconductor waveguide optical regenerative device;

FIG. 4 is a schematic diagram of a computer-controlled semiconductor waveguide optical regenerative device with detectors, lasers, and filters;

FIG. 5 is a schematic diagram of a computer-controlled semiconductor waveguide optical regenerative device with detectors, lasers, and amplifiers;

FIG. 6 is a schematic diagram of a computer-controlled semiconductor waveguide optical regenerative device in which the lasers or source pumps are monolithically integrated to the chip; and

FIG. 7 is a schematic diagram of a computer-controlled semiconductor waveguide optical regenerative device with a switch fabric.

### DETAILED DESCRIPTION

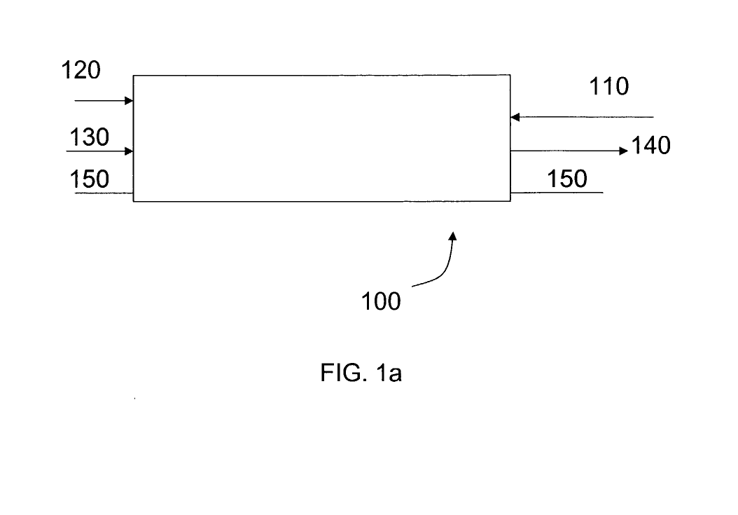

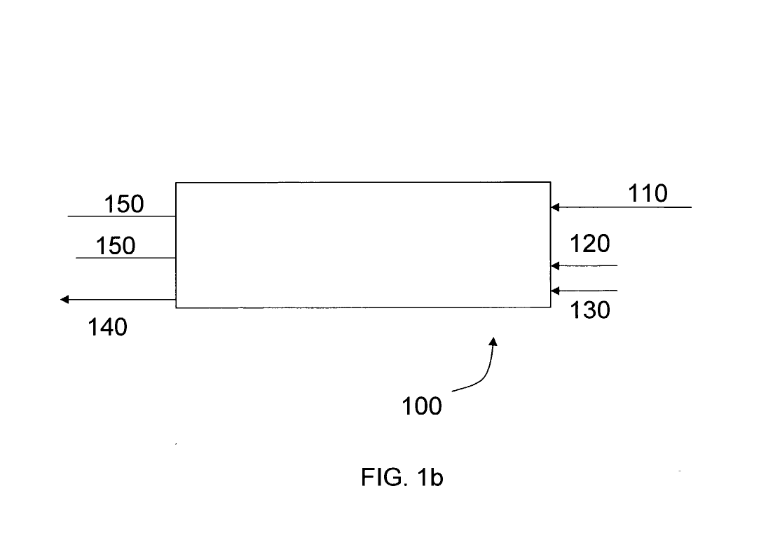

FIG. 1a illustrates an embodiment of a counter propagating semiconductor waveguide optical regenerative device 100. The semiconductor waveguide optical regenerative device has a single input port 110, a primary pump port 120, a secondary pump port 130 and an output port 140. Additional ports 150, are extra ports which can be used for functions like signal monitoring or not used at all. Up to 16 ports can be placed upon a single semiconductor waveguide optical regenerative device. Arrays of semiconductor waveguide optical regenerative devices can facilitate additional ports.

FIG. 1b illustrates an embodiment of a co-propagating semiconductor waveguide optical regenerative device 100 with similar ports 110-150. The semiconductor waveguide optical regenerative device utilizes a resonator cavity to allow the interaction of the co-propagating or counter-propagating input signal and pump wavelengths (local oscillating sources).

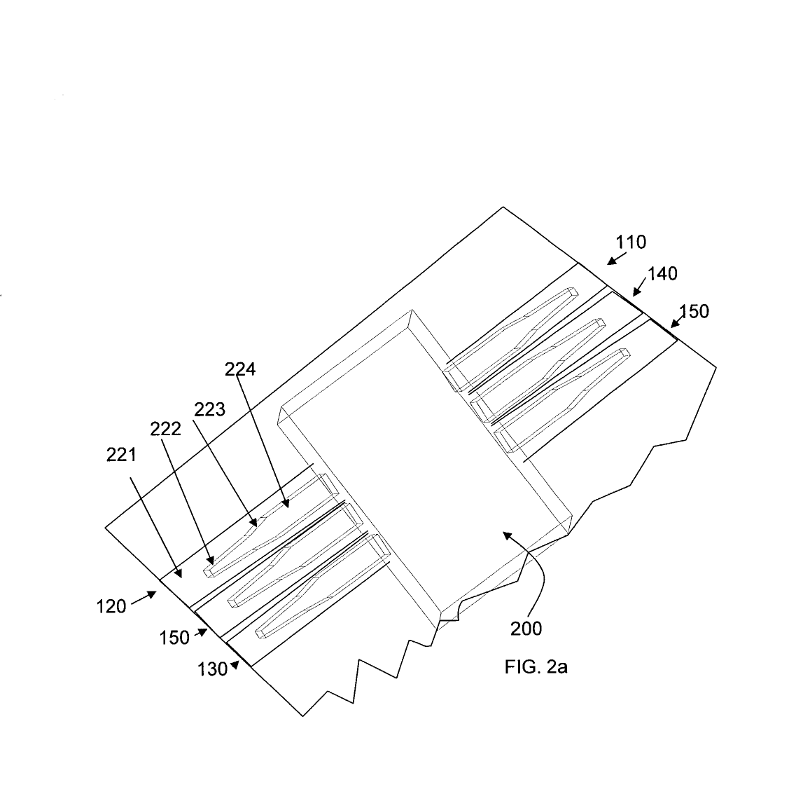

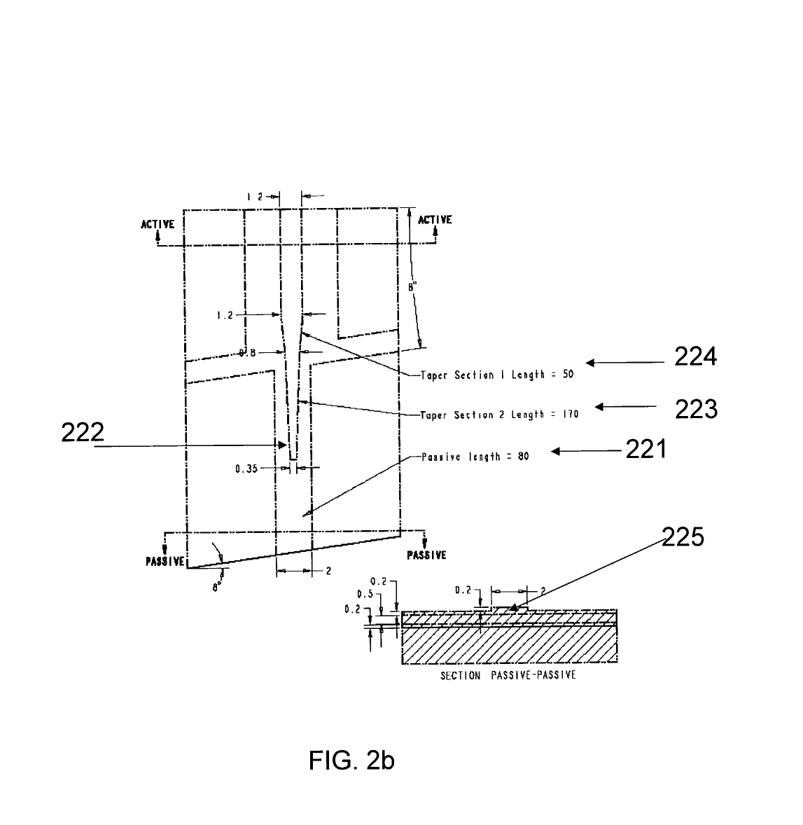

FIGS. 2a and 2b illustrates an embodiment of a semiconductor waveguide optical regenerative device cavity 200 that shows in detail the tapered port structure 120. All ports, 110-150 are designed the same. Light is coupled into the active regions of the semiconductor waveguide optical regenerative device aligning lensed fiber or a fiber lens combination on to chip cleaved facet 225. The waveguide port 120 has been optimized epitaxially to support a particular band of traffic (1310, 1550, etc.) The initially passive ridge is developed to be about 2-6 μm in diameter. The ridge is cleaved from 5-13 degrees from the normal to reduce back reflections from entering or exiting the chip forming the facet 225. Approximately 80 to 120 μm from the cleaved facet 225, the active wave guide is formed. The active regions of the port 120, denoted by 222-224 are tapered from 0.3 μm to 1.5 μm. These regions work with the passive waveguide region 221 to squeeze the light mode from the passive and into the active regions of the waveguide. The purpose of producing the port in this fashion is to minimize light loss from coupling 9 μm fiber external singlemode fiber into a 1 μm active waveguide. The port 120 is fabricated in InP/InGaAs/InGaAsP. The port and the entire semiconductor waveguide optical regenerative device structure is grown as a monolithically integrated bulk ridge waveguide. Even though the device could be created as a buried heterogeous structure, it is produced more cost effectively and efficiently with as a bulk ridge waveguide. This approach advocates low cost and high yield. Designing the structure as a ridge waveguide accomplishes both goals. These ridge structures are created by growing all of the epitaxial layers of the device first by completely additive means of either MOVPE or MBE methods for InP or LiNO3. If other non-linear materials were to be used, processes such as MOCVD or CVD could be used. The essential feature is that all of the epitiaxial composition is deposited first to the correct corresponding device layer thickness. Once the bulk material is deposited, a ridge or laser strip is formed by subsequent etching or shaping processes. No additional epitaxy is grown or deposited to bury the laser stripe.

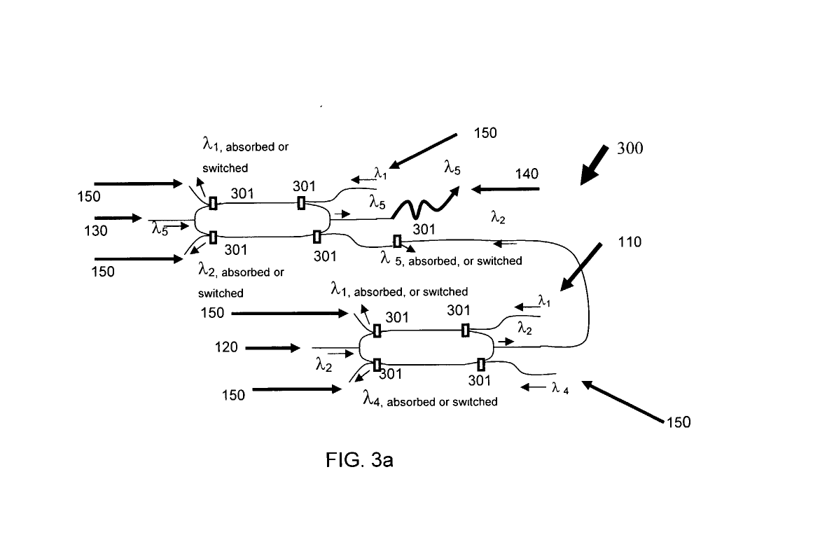

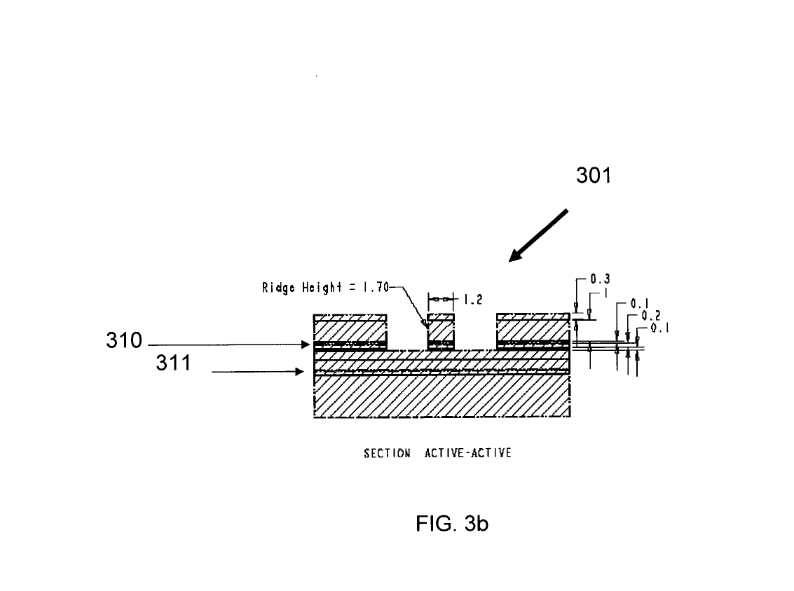

As illustrated in FIG. 3, a semiconductor waveguide optical regenerative device resonator cavity 300 is similar to the semiconductor waveguide optical regenerative device 200 of FIG. 2, and further shows the internal waveguide routing schematic. The resonator cavity is fashion into a series of cascading interferomic ridge waveguides which exploit carrier mobility within the material composition to translate the modulation scheme from the signal entering the probe wavelength port 110 to the final pump wavelength entering from port 130. The routing within the device is controlled by current density manipulating the regions of the interferomic structure. Moreover, the internal wavelength routing can be further enhanced by the deposition and control of directional mode couplers 501. By manipulating the flow of signals within the semiconductor waveguide optical regenerative device resonator cavity, the same waveguide device can be used in either co-progating or counter-propogating signal flow. This allows for the semiconductor waveguide optical regenerative device to be used for other applications such as switching and routing, in addition to wavelength conversion.

As illustrated in FIG. 3b, the resonator cavity's 300 internal waveguides are also ridge waveguide structures. The ridge structure of the waveguides is deposited in sequence above the passive waveguide structure, with particular care in selection of the corresponding or subsequent layer's epitaxy and if the layer is designed to aid in light transport or confinement. The complexity of the waveguides is resolved by selective etching. This process results in higher yields and reduced numbers of steps when compared to creating a buried structure or by trying to deposit differing compositions to the same layer to deliver the same functionality. The approach to designing and manufacturing these waveguide structures is to design in a 2-D and to allow allow distinct layers to possess specific functionality. In FIG. 3b, the original passive layer 311 from the port 110-150 structures is visible beneath the active layer 310. The functionality of the layer 310 is not impeded by the functionality of layer 311. Moreover, the chip design did not require that layer 310 and layer 311 be placed in the same Z height plane. Designing in 2-D with proper isolation or mode squeezing contact allows for complex ridge waveguide structures to be built without burying the structure in InP or some other non-linear semiconductor material or having to process the geometry without repeated series of material deposition and etch combinations.

As illustrated in FIG. 2b and FIG. 3b, the ridge structures average from 0.3 μm to 1.2 μm. Wire bonding needed to disseminate current through out the ridge structure or to targeted regions of the ridge structure is sized on the order of 6 to 10 μm. In order to facilitate connectivity with the ridge, bond pad plateaus are grown around the geometry and isolated by nitrides or special epitaxial compositions from conducting current. To fill the gaps created by the ridge and plateau structures, a low dielectric k type material like BCB is deposited and used to planarize the topography. The low dielectric k material is chosen with an appropriate index of refraction value to aid in helping to confine light horizontally within the ridge structures. Moreover, confinement is obtained without requiring additional epitaxial growth and deposition steps. The side walls of the active waveguide is being devoid of additional epitaxial growth processes after the shaping etch, will remain smoother and allow less light to be absorbed in side walls roughened by regrowth.

The material has sufficient properties to survive deposition of an electrode on the surface of the low dielectric k type material to connect the ridge to the bond pad plateau. The bond pads are quite large and can sufficiently support the wire bonds while the electrodes connect current from the wire bonds to the fine geometry of the ridge. The bond plateau's also serve as a alignment tool for the packaging process.

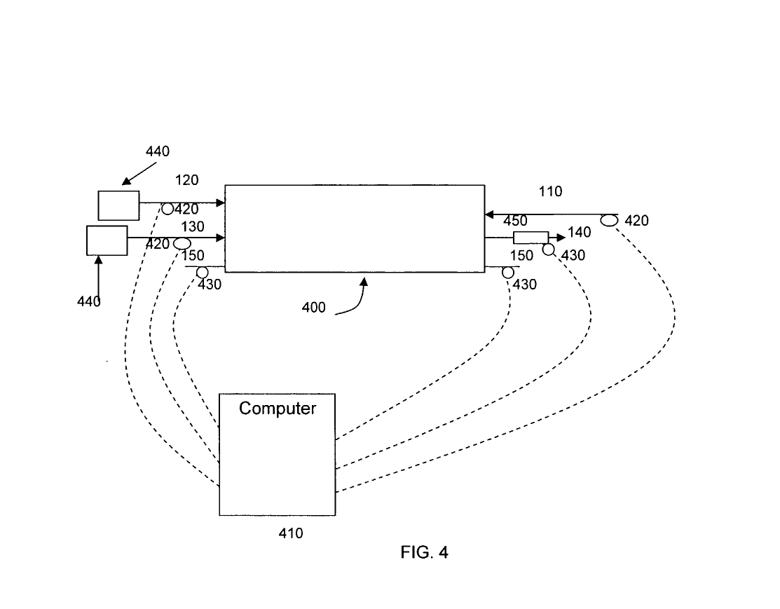

Illustrated in FIG. 4 is the semiconductor waveguide optical regenerative device 400 which includes a computer 410, an input signal monitor 420, and an output signal monitor 430. The computer 410 communicates with a tunable or fixed source 440, and a tunable wavelength filter 450, adjusting these tunable elements. Adjustments may be based on operator inputs received from port 420, based on data received from the monitor 420, and on data received from the monitor 430. The data may include signal power and/or wavelength data. For example, automated routines can be prescribed and triggered by the detection of predetermined incoming wavelengths. The computer 410 may be a general purpose computer, e.g., a Wintel machine, a microcontroller, a semi-custom application specific integrated circuit, or a custom data processing device.

As in the case of a one-output converter, the multi-output version may also include monitors for the input and/or output signals, and a computer responsive to operator inputs and to the data provided by the monitors.

In addition to wavelength filters, such as the filter or a wavelength-selective element may also be incorporated on the input or output of the semiconductor waveguide optical regenerative device to improve signal to noise ratio and extinction ratio of input and output signals.

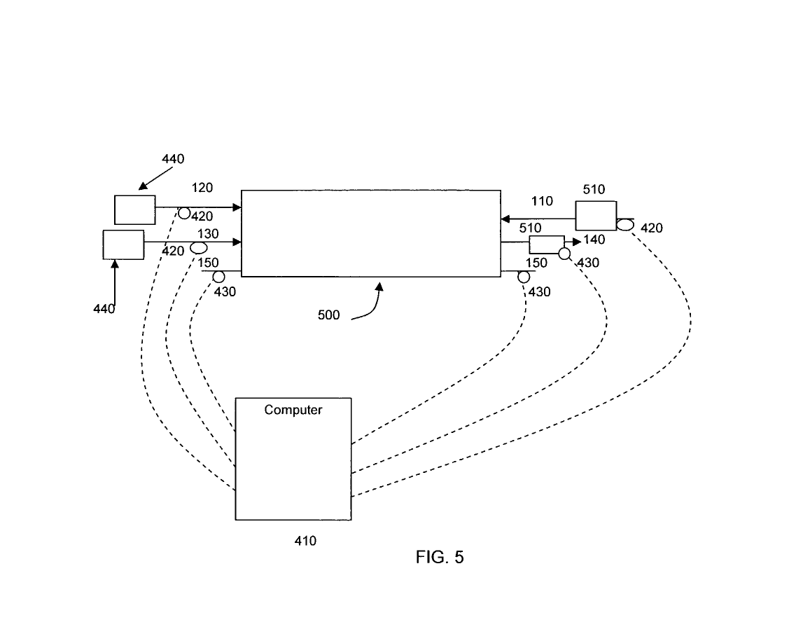

To compensate for signal attenuation in the different components of the semiconductor waveguide optical regenerative device, such as signal loss inherent in the power splitter, the semiconductor waveguide optical regenerative device may include an active fiber portion for amplifying the signal. FIG. 5 illustrates a semiconductor waveguide optical regenerative device 500, which is similar to the semiconductor waveguide optical regenerative device 400 illustrated in FIG. 4, but also includes an active fiber portion 510 that amplifies the signal or signals output by the semiconductor waveguide optical regenerative device. The active fiber portion 510 can compensate for some or all of the losses in the semiconductor waveguide optical regenerative device; it can also overcompensate for the losses, providing a net amplification effect in the semiconductor waveguide optical regenerative device.

Typical active fiber is fiber doped with rare earth element ions. The doped fiber becomes fluorescent, meaning that it can absorb excitation energy at one wavelength and emit the absorbed energy at a different wavelength. To provide optical amplification, active fiber is excited or “pumped” by a source of light (an “optical pump”), e.g., a diode laser, elevating the energy states of the fiber's constituent particles. The particles then emit light when triggered by the propagating signal at the signal's wavelength, thus amplifying the signal. Fluorescent dopants often used in active fiber of non-coherent optical systems operating in the 1310 nm and 1550 nm bands are erbium and praseodymium.

Active fiber, as most amplifiers, produces spontaneous wideband emissions, i.e., noise. Noise in communication systems is, of course, undesirable. One way to lower an amplifier's noise figure is to pass the amplified signal through a narrow band-pass filter. The passband of the filter needs to be at least as broad as the signal, so that a part of the signal itself is not filtered out. Thus, the filtering approach to noise reduction does not work well for wideband signals.

Semiconductor optical amplifiers may also be used to boost the input and output signals of semiconductor waveguide optical regenerative device. Because such devices are typically made from nonlinear semiconductor materials like InP, these devices could be monolithically integrated with the semiconductor waveguide optical regenerative device.

The semiconductor waveguide optical regenerative device 500, however, may provide amplification with a relatively small penalty to the noise figure of the device if the output filters are sufficiently narrowband. This benefit results because the noise contribution of the active fiber portion 510, as well as the unwanted ASE noise will be filtered out by the output filters.

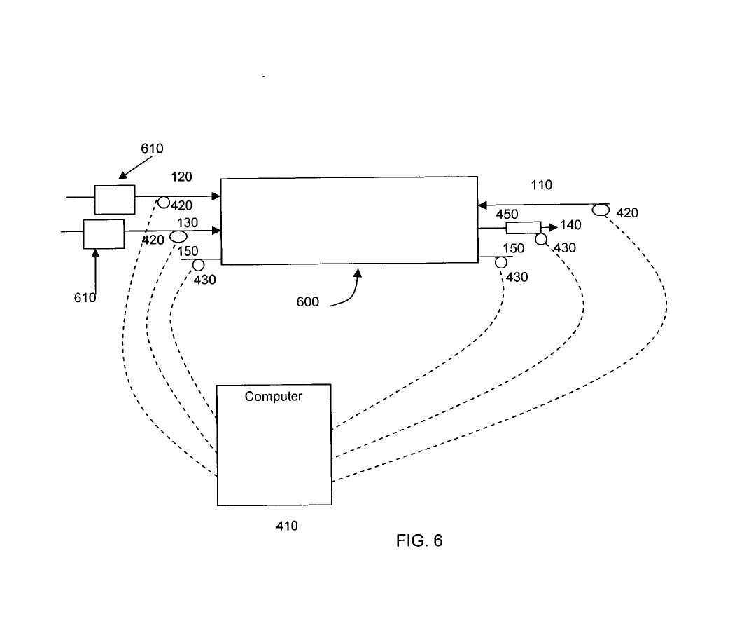

Active fiber uses an optical pump to provide energy needed for signal amplification. The optical pump can be part of the semiconductor waveguide optical regenerative device, or separate therefrom. The former arrangement is illustrated in FIG. 6, in which semiconductor waveguide optical regenerative device 600 is similar to the converter 500 which includes an optical pump 610 coupled to the waveguide port 120 and 130. The optical pump 610 may be a laser diode, tunable laser or fixed wavelength laser. The laser source may also be monolithically integrated into the semiconductor waveguide optical regenerative device.

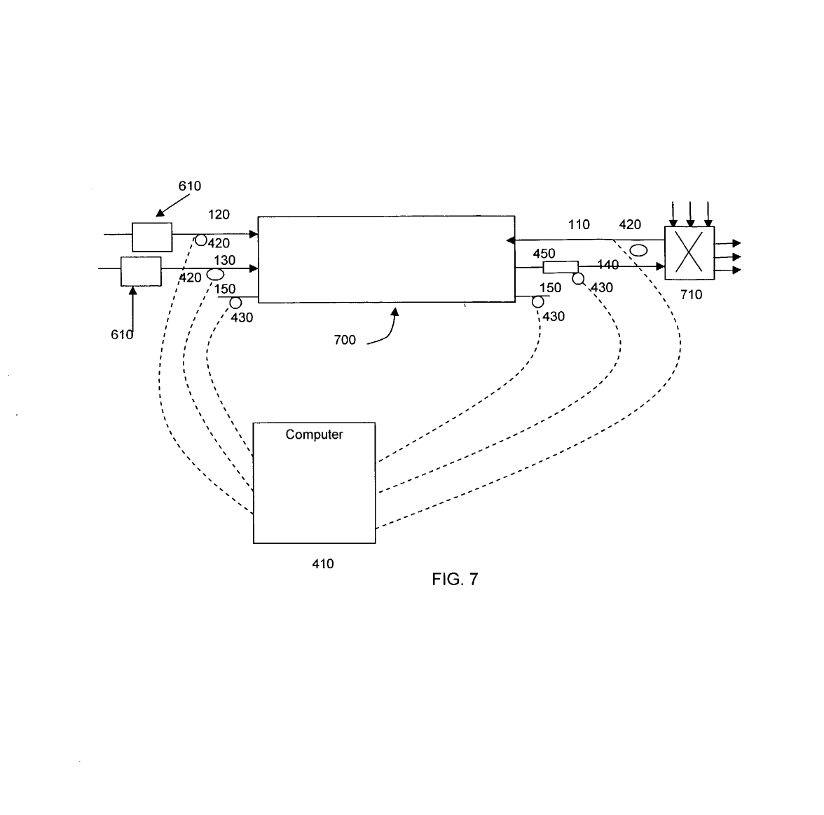

FIG. 7 shows an embodiment a semiconductor waveguide optical regenerative device 700 which is similar to the embodiment 600. This device is integrated with a switch or cross-connect fabric. These devices may be discrete or monolithically integrated structures.

We have described the inventive semiconductor waveguide optical regenerative device and some of its features in considerable detail for illustration purposes only. Neither the specific embodiments of the invention as a whole nor those of its features limit the general principles underlying the invention. In particular, the invention is not limited to specific regions of the light spectrum mentioned in this document, or to use in WDM optical transmission systems. The specific ridge waveguide structures, multi-mode waveguide couplers, filters, mode squeezing passive waveguide ports, and active fiber fillers described may be used in some embodiments, but not in others, without departure from the spirit and scope of the invention as set forth. Different geometries of the semiconductor waveguide optical regenerative device and of the active fiber filler also fall within the intended scope of the invention. Furthermore, the use of active fiber, filters and amplifiers on the outputs is optional. Many additional modifications are intended in the foregoing disclosure, and it will be appreciated by those of ordinary skill in the art that in some instances some features of the invention will be employed in the absence of a corresponding use of other features. The illustrative examples therefore do not define the metes and bounds of the invention, which function has been reserved for the following claims and their equivalents.

We claim:

1. A semiconductor waveguide optical regenerative device, photonic application-specific integrated circuit, comprising:
an optical ridge wave-guiding structure comprising at least one output, a first input for receiving an input signal, a second input for receiving a local oscillator signal, and a third input for receiving a local oscillator signal; and
an optical ridge waveguide resonator structure or network of structures for utilizing carrier inversion to translate the modulation scheme from the input signal to one or more of the local oscillator signals or create a new wavelength with modulation scheme of the input signal.

2. A semiconductor waveguide optical regenerative device, photonic application-specific integrated circuit according to claim 1, wherein the output and inputs are comprised of ridge waveguide structures with compositional and geometrical changes to promote an active passive transition for the emission, amplification and transport of light.

3. A semiconductor waveguide optical regenerative device according to claim 2, possess both active and passive ridge waveguides that are monolithically integrated.

4. A semiconductor waveguide optical regenerative device according to claim 2, utilizes the active passive transition as a mode-squeezing device to facilitate light passage from fiber into the waveguides and into the resonator cavity of the device with minimal light loss.

5. A semiconductor waveguide optical regenerative device according to claim 1, further comprising two local oscillating sources fiber used as pumps or lasers for excitation or interaction with the input signal.

6. A semiconductor waveguide optical regenerative device according to claim 5, the local oscillating sources can be any combination of laser (fixed wavelength or tunable), laser diode, light pump.

7. A semiconductor waveguide optical regenerative device according to claim 6, further comprising a local oscillator source for producing the local oscillator signal, the local oscillator source being optically coupled or monolithically integrated to the second input of the optical waveguiding structure.

8. A semiconductor waveguide optical regenerative device according to claim 6, further comprising a local oscillator source for producing the local oscillator signal, the local oscillator source being optically coupled or monolithically integrated to the third input of the optical wave-guiding structure.

9. A semiconductor waveguide optical regenerative device according to claim 1, further comprising, or monolithically integrated, two local amplifiers used to increase the amplitude of the input and output signals.

10. A semiconductor waveguide optical regenerative device according to claim 9, the amplifier sources can be any combination of doped fiber or semiconductor optical amplifier.

11. A semiconductor waveguide optical regenerative device according to claim 10, further comprising a local amplifier source for producing amplifying or attenuating the input signal, the local amplifier source being optically coupled or monolithically integrated to the first input of the optical wave-guiding structure.

12. A semiconductor waveguide optical regenerative device according to claim 6, further comprising a local amplifier source for amplifying or attenuating the output signal, the local amplifier source being optically coupled or monolithically integrated to the third output of the optical wave-guiding structure.

13. A semiconductor waveguide optical regenerative device according to claim 1, further comprising two local filtering sources, or monolithically integrated, fiber used to filter the input signal and/or the output signal.

14. A semiconductor waveguide optical regenerative device according to claim 13, the local filtering sources can be any combination of fixed or tunable filter (fabry perot, acoustic, bragg, mach-zehnder, etc.) and may be monolithically integrated.

15. A semiconductor waveguide optical regenerative device according to claim 14, further comprising a local filtering source for filtering or correcting dispersion of the input signal the local oscillator signal, the local filtering source being optically coupled or monolithically integrated to the first input of the optical wave-guiding structure.

16. A semiconductor waveguide optical regenerative device according to claim 15, further comprising a local filtering source for filtering or correcting dispersion of the output signal, the local filtering source being optically coupled or monolithically integrated to the output of the optical wave-guiding structure.

17. A semiconductor waveguide optical regenerative device according to claim 16, wherein the device comprises filters, amplifiers, the ridge waveguide structure and the local oscillator sources comprises a tunable source capable of producing the local oscillator signals in a range of wavelengths, or monolithically integrated into the same common substrate.

18. A semiconductor waveguide optical regenerative device according to claim 17, further comprising a computer, microprocessor, application-specific integrated circuit (ASIC), or field-programmable gate array (FPGA) coupled to the ridge waveguide resonator structure, to the filters, and to the local oscillator sources, the computer, microprocessor, ASIC, or FPGA being capable of tuning and/or monitoring the waveguide structure, the filters, amplifiers and the local oscillator source, or monolithically integrated into the same common substrate.

19. A semiconductor waveguide optical regenerative device according to claim 18, further comprising:
a first signal monitor capable of providing to the computer (microprocessor, ASIC, or FPGA) signal power and wavelength data relating to the input signal; and
a second signal monitor capable of providing to the computer (microprocessor, ASIC, or FPGA) signal power and wavelength data relating to the output signal;
additional monitors associated with the local oscillating sources, amplifiers, and/or filters, or monolithically integrated into the same common substrate;
wherein the computer tunes the ridge waveguide resonator structure, filters, amplifiers, and the local oscillator sources in response to the data provided by the first signal monitor and the second signal monitor.

20. A semiconductor waveguide optical regenerative device according to claim 1, wherein the ridgewave structure comprises a InP/InGaAsP/InGaAs epitaxial or other nonlinear semiconductor composed medium.

21. A semiconductor waveguide optical regenerative device according to claim 20, wherein the quasi-phasematching structure further comprises a plurality of electrodes and a voltage source coupled to the electrodes for to promote carrier inversion or cross-phase modulation within the medium.

22. A semiconductor waveguide optical regenerative device according to claim 21, wherein the electrodes are lithographically deposed on the structure.

23. A semiconductor waveguide optical regenerative device according to claim 22, wherein the electrically isolated plateau are monolithically integrated with the ridgewave guide structure and are utilized to support wire bonding and fiber alignment.

24. A semiconductor waveguide optical regenerative device according to claim 23, wherein the ridgewave guide structure is confined with planarizing low dielectric K material.

25. A semiconductor waveguide optical regenerative device comprising:
an optical ridge waveguiding structure comprising at least one output, a first input for receiving an input signal, a second input for receiving a local oscillator signal, and a third input for receiving a local oscillator signal; and
an optical ridge waveguide resonator structure or network of structures for utilizing wave mixing to translate the modulation scheme from the input signal to one or more of the local oscillator signals or create a new wavelength with modulation scheme of the input signal.

26. A semiconductor waveguide optical regenerative device according to claim 25, wherein the output and inputs are comprised of ridge waveguide structures with compositional and geometrical changes to promote an active passive transition for the transport of light.

27. A semiconductor waveguide optical regenerative device according to claim 26, possess both active and passive ridge waveguides that are monolithically integrated.

28. A semiconductor waveguide optical regenerative device according to claim 27, utilizes the active passive transition as a mode-squeezing device to facilitate light passage from fiber into the waveguides and into the resonator cavity of the device with minimal light loss.

29. A semiconductor waveguide optical regenerative device according to claim 25, further comprising two local oscillating sources fiber used as pumps or lasers for excitation or interaction with the input signal.

30. A semiconductor waveguide optical regenerative device according to claim 29, the local oscillating sources can be any combination of laser (fixed wavelength or tunable), laser diode, light pump.

31. A semiconductor waveguide optical regenerative device according to claim 30, further comprising a local oscillator source for producing the local oscillator signal, the local oscillator source being optically coupled or monolithically integrated to the second input of the optical wave-guiding structure.

32. A semiconductor waveguide optical regenerative device according to claim 31, further comprising a local oscillator source for producing the local oscillator signal, the local oscillator source being optically coupled or monolithically integrated to the third input of the optical wave-guiding structure.

33. A semiconductor waveguide optical regenerative device according to claim 25, further comprising two local amplifier used to increase the amplitude of the input and output signals.

34. A semiconductor waveguide optical regenerative device according to claim 33, the amplifier sources can be any combination of doped fiber or semiconductor optical amplifier, or monolithically integrated into the common substrate.

35. A semiconductor waveguide optical regenerative device according to claim 34, further comprising a local amplifier source for producing amplifying or attenuating the input signal, the local amplifier source being optically coupled or monolithically integrated to the first input of the optical wave-guiding structure.

36. A semiconductor waveguide optical regenerative device according to claim 35, further comprising a local amplifier source for amplifying or attenuating the output signal, the local amplifier source being optically coupled or monolithically integrated to the third output of the optical wave-guiding structure.

37. A semiconductor waveguide optical regenerative device according to claim 25, further comprising two local filtering sources fiber used to filter the input signal and/or the output signal.

38. A semiconductor waveguide optical regenerative device according to claim 37, the local filtering sources can be any combination of fixed or tunable filter (fabry perot, acoustic, bragg, mach-zehnder, etc.)

39. A semiconductor waveguide optical regenerative device according to claim 38, further comprising a local filtering source for filtering or correcting dispersion of the input signal the local oscillator signal, the local filtering source being optically coupled or monolithically integrated to the first input of the optical wave-guiding structure.

40. A semiconductor waveguide optical regenerative device according to claim 39, further comprising a local filtering source for filtering or correcting dispersion of the output signal, the local filtering source being optically coupled or monolithically integrated to the output of the optical wave-guiding structure.

41. A semiconductor waveguide optical regenerative device according to claim 40, wherein the device comprises filters, amplifiers, the ridge waveguide structure and the local oscillator sources comprises a tunable source capable of producing the local oscillator signals in a range of wavelength.

42. A semiconductor waveguide optical regenerative device according to claim 41, further comprising a computer coupled to the ridge waveguide resonator structure, to the filters, and to the local oscillator sources, the computer being capable of tuning and/or monitoring the waveguide structure, the filters, amplifiers and the local oscillator source.

43. A semiconductor waveguide optical regenerative device according to claim 42, further comprising:
a first signal monitor capable of providing to the computer signal power and wavelength data relating to the input signal; and
a second signal monitor capable of providing to the computer signal power and wavelength data relating to the output signal;
additional monitors associated with the local oscillating sources, amplifiers, and/or filters;
wherein the computer tunes the ridge waveguide resonator structure, filters, amplifiers, and the local oscillator sources in response to the data provided by the first signal monitor and the second signal monitor.

43. A semiconductor waveguide optical regenerative device according to claim 25, wherein the ridgewave structure comprises a InP/InGaAsP/InGaAs epitaxial or other nonlinear semiconductor composed medium.

44. A semiconductor waveguide optical regenerative device according to claim 43, wherein the quasi-phasematching structure further comprises a plurality of electrodes and a voltage source coupled to the electrodes for to promote carrier inversion or cross-phase modulation within the medium.

45. A semiconductor waveguide optical regenerative device according to claim 44, wherein the electrodes are lithographically deposed on the structure.

46. A semiconductor waveguide optical regenerative device according to claim 45, wherein the electrically isolated plateau are monolithically integrated with the ridgewave guide structure and are utilized to support wire bonding and fiber alignment.

47. A semiconductor waveguide optical regenerative device according to claim 46, wherein the ridgewave guide structure is confined with planarizing low dielectric K material.

48. A semiconductor waveguide optical regenerative device comprising:
an optical ridge waveguiding structure comprising at least one output, a first input for receiving an input signal, a second input for receiving a local oscillator signal, and a third input for receiving a local oscillator signal; and
an optical ridge waveguide resonator structure or network of structures for utilizing cross-phase modulation to translate the modulation scheme from the input signal to one or more of the local oscillator signals or create a new wavelength with modulation scheme of the input signal.

49. A semiconductor waveguide optical regenerative device according to claim 48, wherein the output and inputs are comprised of ridge waveguide structures with compositional and geometrical changes to promote an active passive transition for the transport of light.

50. A semiconductor waveguide optical regenerative device according to claim 49, possess both active and passive ridge waveguides that are monolithically integrated.

51. A semiconductor waveguide optical regenerative device according to claim 50, utilizes the active passive transition as a mode-squeezing device to facilitate light passage from fiber into the waveguides and into the resonator cavity of the device with minimal light loss.

52. A semiconductor waveguide optical regenerative device according to claim 48, further comprising two local oscillating sources fiber used as pumps or lasers for excitation or interaction with the input signal.

53. A semiconductor waveguide optical regenerative device according to claim 52, the local oscillating sources can be any combination of laser (fixed wavelength or tunable), laser diode, light pump.

54. A semiconductor waveguide optical regenerative device according to claim 53, further comprising a local oscillator source for producing the local oscillator signal, the local oscillator source being optically coupled or monolithically integrated to the second input of the optical wave-guiding structure.

55. A semiconductor waveguide optical regenerative device according to claim 54, further comprising a local oscillator source for producing the local oscillator signal, the local oscillator source being optically coupled or monolithically integrated to the third input of the optical wave-guiding structure.

56. A semiconductor waveguide optical regenerative device according to claim 48, further comprising two local amplifier used to increase the amplitude of the input and output signals.

57. A semiconductor waveguide optical regenerative device according to claim 56, the amplifier sources can be any combination of doped fiber or semiconductor optical amplifier.

58. A semiconductor waveguide optical regenerative device according to claim 57, further comprising a local amplifier source for producing amplifying or attenuating the input signal, the local amplifier source being optically coupled or monolithically integrated to the first input of the optical wave-guiding structure.

59. A semiconductor waveguide optical regenerative device according to claim 58, further comprising a local amplifier source for amplifying or attenuating the output signal, the local amplifier source being optically coupled or monolithically integrated to the third output of the optical wave-guiding structure.

60. A semiconductor waveguide optical regenerative device according to claim 48, further comprising two local filtering sources fiber used to filter the input signal and/or the output signal.

61. A semiconductor waveguide optical regenerative device according to claim 60, the local filtering sources can be any combination of fixed or tunable filter (fabry perot, acoustic, bragg, mach-zehnder, etc.)

62. A semiconductor waveguide optical regenerative device according to claim 61, further comprising a local filtering source for filtering or correcting dispersion of the input signal the local oscillator signal, the local filtering source being optically coupled or monolithically integrated to the first input of the optical wave-guiding structure.

63. A semiconductor waveguide optical regenerative device according to claim 62, further comprising a local filtering source for filtering or correcting dispersion of the output signal, the local filtering source being optically coupled or monolithically integrated to the output of the optical wave-guiding structure.

64. A semiconductor waveguide optical regenerative device according to claim 63, wherein the device comprises filters, amplifiers, the ridge waveguide structure and the local oscillator sources comprises a tunable source capable of producing the local oscillator signals in a range of wavelength.

65. A semiconductor waveguide optical regenerative device according to claim 64, further comprising a computer coupled to the ridge waveguide resonator structure, to the filters, and to the local oscillator sources, the computer being capable of tuning and/or monitoring the waveguide structure, the filters, amplifiers and the local oscillator source.

66. A semiconductor waveguide optical regenerative device according to claim 65, further comprising:
a first signal monitor capable of providing to the computer signal power and wavelength data relating to the input signal; and
a second signal monitor capable of providing to the computer signal power and wavelength data relating to the output signal;
additional monitors associated with the local oscillating sources, amplifiers, and/or filters;
wherein the computer tunes the ridge waveguide resonator structure, filters, amplifiers, and the local oscillator sources in response to the data provided by the first signal monitor and the second signal monitor.

67. A semiconductor waveguide optical regenerative device according to claim 48, wherein the ridgewave structure comprises a InP/InGaAsP/InGaAs epitaxial or other nonlinear semiconductor composed medium.

68. A semiconductor waveguide optical regenerative device according to claim 67, wherein the quasi-phasematching structure further comprises a plurality of electrodes and a voltage source coupled to the electrodes for to promote carrier inversion or cross-phase modulation within the medium.

69. A semiconductor waveguide optical regenerative device according to claim 68, wherein the electrodes are lithographically deposed on the structure.

70. A semiconductor waveguide optical regenerative device according to claim 69, wherein the electrically isolated plateau are monolithically integrated with the ridgewave guide structure and are utilized to support wire bonding and fiber alignment.

71. A semiconductor waveguide optical regenerative device according to claim 70, wherein the ridgewave guide structure is confined with planarizing low dielectric K material.

72. A semiconductor waveguide optical regenerative device comprising:
an optical ridge wave-guiding structure comprising at least one output, a first input for receiving an input signal, a second input for receiving a local oscillator signal, and a third input for receiving a local oscillator signal; and
an optical ridge waveguide resonator structure or network of structures for utilizing carrier inversion, wave mixing and/or cross phase modulation to translate the modulation scheme from the input signal to one or more of the local oscillator signals or create a new wavelength with modulation scheme of the input signal.

73. A semiconductor waveguide optical regenerative device according to claim 72, wherein the output and inputs are comprised of ridge waveguide structures with compositional and geometrical changes to promote an active passive transition for the transport of light.

74. A semiconductor waveguide optical regenerative device according to claim 73, possess both active and passive ridge waveguides that are monolithically integrated.

75. A semiconductor waveguide optical regenerative device according to claim 74, utilizes the active passive transition as a mode-squeezing device to facilitate light passage from fiber into the waveguides and into the resonator cavity of the device with minimal light loss.

76. A semiconductor waveguide optical regenerative device according to claim 72, further comprising two local oscillating sources fiber used as pumps or lasers for excitation or interaction with the input signal.

77. A semiconductor waveguide optical regenerative device according to claim 76, the local oscillating sources can be any combination of laser (fixed wavelength or tunable), laser diode, light pump.

78. A semiconductor waveguide optical regenerative device according to claim 77, further comprising a local oscillator source for producing the local oscillator signal, the local oscillator source being optically coupled or monolithically integrated to the second input of the optical wave-guiding structure.

79. A semiconductor waveguide optical regenerative device according to claim 78, further comprising a local oscillator source for producing the local oscillator signal, the local oscillator source being optically coupled or monolithically integrated to the third input of the optical wave-guiding structure.

80. A semiconductor waveguide optical regenerative device according to claim 72, further comprising two local amplifier used to increase the amplitude of the input and output signals.

81. A semiconductor waveguide optical regenerative device according to claim 80, the amplifier sources can be any combination of doped fiber or semiconductor optical amplifier.

82. A semiconductor waveguide optical regenerative device according to claim 81, further comprising a local amplifier source for producing amplifying or attenuating the input signal, the local amplifier source being optically coupled or monolithically integrated to the first input of the optical wave-guiding structure.

83. A semiconductor waveguide optical regenerative device according to claim 82, further comprising a local amplifier source for amplifying or attenuating the output signal, the local amplifier source being optically coupled or monolithically integrated to the third output of the optical wave-guiding structure.

84. A semiconductor waveguide optical regenerative device according to claim 72, further comprising two local filtering sources fiber used to filter the input signal and/or the output signal.

85. A semiconductor waveguide optical regenerative device according to claim 84, the local filtering sources can be any combination of fixed or tunable filter (fabry perot, acoustic, bragg, mach-zehnder, etc.)

86. A semiconductor waveguide optical regenerative device according to claim 85, further comprising a local filtering source for filtering or correcting dispersion of the input signal the local oscillator signal, the local filtering source being optically coupled or monolithically integrated to the first input of the optical wave-guiding structure.

87. A semiconductor waveguide optical regenerative device according to claim 86, further comprising a local filtering source for filtering or correcting dispersion of the output signal, the local filtering source being optically coupled or monolithically integrated to the output of the optical wave-guiding structure.

88. A semiconductor waveguide optical regenerative device according to claim 87, wherein the device comprises filters, amplifiers, the ridge waveguide structure and the local oscillator sources comprises a tunable source capable of producing the local oscillator signals in a range of wavelength.

89. A semiconductor waveguide optical regenerative device according to claim 88, further comprising a computer coupled to the ridge waveguide resonator structure, to the filters, and to the local oscillator sources, the computer being capable of tuning and/or monitoring the waveguide structure, the filters, amplifiers and the local oscillator source.

90. A semiconductor waveguide optical regenerative device according to claim 89, further comprising:
a first signal monitor capable of providing to the computer signal power and wavelength data relating to the input signal; and
a second signal monitor capable of providing to the computer signal power and wavelength data relating to the output signal;
additional monitors associated with the local oscillating sources, amplifiers, and/or filters;
wherein the computer tunes the ridge waveguide resonator structure, filters, amplifiers, and the local oscillator sources in response to the data provided by the first signal monitor and the second signal monitor.

91. A semiconductor waveguide optical regenerative device according to claim 72, wherein the ridgewave structure comprises a polymer medium with semiconductor dopant.

92. A semiconductor waveguide optical regenerative device according to claim 91, wherein the quasi-phasematching structure further comprises a plurality of electrodes and a voltage source coupled to the electrodes for to promote carrier inversion or cross-phase modulation within the medium.

93. A semiconductor waveguide optical regenerative device according to claim 92, wherein the electrodes are lithographically deposed on the structure.

94. A semiconductor waveguide optical regenerative device according to claim 93, wherein the electrically isolated plateau are monolithically integrated with the ridgewave guide structure and are utilized to support wire bonding and fiber alignment.

95. A semiconductor waveguide optical regenerative device according to claim 94, wherein the ridgewave guide structure is confined with planarizing low dielectric K material.

96. A method for converting wavelength of an optical signal in an integral device, the method comprising the following steps:
step for mixing the optical signal with a local oscillator signal having a local oscillator wavelength in a quasi-phasematching structure within the device to obtain a wavelength-shifted mixing product; and
step for filtering, within the device, the wavelength-shifted mixing product.

97. A method according to claim 96, further comprising a step for amplifying, within the device, the wavelength-shifted mixing product before said step for filtering.

98. A method for converting wavelength of an optical signal in an integral device, the method comprising the following steps:
step for invoking carrier density inversion to allow wavelength translation of the modulation scheme from the input signal to a local oscillator signal with the a ridge waveguide structure within the device to obtain a wavelength translated or converted signal.
step for filtering, within the device, local oscillating wavelengths and original signal.

99. A method according to claim 98, further comprising a step for amplifying, within the device, the wavelength-shifted or translated product before exiting the structure or filtering.

100. A method for converting wavelength of an optical signal in an integral device, the method comprising the following steps:
step for mixing the optical signal with a local oscillator signal having cross phase modulation occur to translate the modulation information onto the local oscillator wavelength within a ridge waveguide structure within the device; and
step for filtering, within the device, local oscillating wavelengths and the original signal.

101. A method according to claim 100, further comprising a step for amplifying, within the device, the wavelength translated product before said step for filtering.

102. A semiconductor waveguide optical regenerative device comprising:
an optical waveguiding structure comprising a first input for receiving an input signal including a first wavelength component at a first wavelength, at least one input for local oscillator signal, and at least one output;
a ridgewave structure for mixing the input signal and the local oscillator signals to produce converted, translated or mixed output signals at the output of the optical waveguiding structure;
a switch fabric optically coupled to the ridge waveguide input; and
a plurality of output paths.

103. A semiconductor waveguide optical regenerative device comprising:
an optical waveguiding structure comprising a first input for receiving an input signal including a first wavelength component at a first wavelength, at least one input for local oscillator signal, and at least one output;
a ridgewave structure for mixing the input signal and the local oscillator signals to produce converted, translated or mixed output signals at the output of the optical waveguiding structure;
a switch fabric optically coupled to the ridge waveguide output;

104. A semiconductor waveguide optical regenerative device comprising:
an optical waveguiding structure comprising a first input for receiving an input signal including a first wavelength component at a first wavelength, at least one input for local oscillator signal, and at least one output;
a ridgewave structure for mixing the input signal and the local oscillator signals to produce converted, translated or mixed output signals at the output of the optical waveguiding structure;
a switch fabric optically coupled and monolithically integrated to the ridge waveguide input; and
a plurality of output paths.

105. A semiconductor waveguide optical regenerative device comprising:
an optical waveguiding structure comprising a first input for receiving an input signal including a first wavelength component at a first wavelength, at least one input for local oscillator signal, and at least one output;
a ridgewave structure for mixing the input signal and the local oscillator signals to produce converted, translated or mixed output signals at the output of the optical waveguiding structure;
a switch fabric optically coupled and monolithically integrated to the ridge waveguide output;

106. A semiconductor waveguide optical regenerative device comprising:
an optical waveguiding structure comprising a first input for receiving an input signal including a first wavelength component at a first wavelength, at least one input for local oscillator signal, and at least one output;
a ridge waveguide structure used to route or switch signals.

107. A semiconductor waveguide optical regenerative device comprising:
an optical wave-guiding structure comprising a first input for receiving an input signal including a first wavelength component at a first wavelength, at least one input for local oscillator signal, and at least one output;
a ridge waveguide structure used as an optical transponder to optically transmit and receive optical signals monolithically integrated with a signal modulator.

108. A semiconductor waveguide optical regenerative device comprising:
an optical wave-guiding structure comprising a first input for receiving an input signal including a first wavelength component at a first wavelength, at least one input for local oscillator signal, and at least one output;
a ridge waveguide structure is coupled and monolithically integrated with electronic circuitry to produce hybrid optoelectronic interconnects.

109. A semiconductor waveguide optical regenerative device comprising:
an optical wave-guiding structure comprising a first input for receiving an input signal including a first wavelength component at a first wavelength, at least one input for local oscillator signal, and at least one output;
a ridge waveguide structure coupled with electronic circuitry to produce monolithically integrated hybrid optoelectronic microprocessor, hybrid optoelectronic application-specific integrated circuit, hybrid optoelectronic field-programmable gate array or hybrid optoelectronic computer.

110. A semiconductor waveguide optical regenerative device comprising:
an optical wave-guiding structure comprising a first input for receiving an input signal including a first wavelength component at a first wavelength, at least one input for local oscillator signal, and at least one output;
a ridge waveguide structure is coupled and monolithically integrated with electronic circuitry to produce hybrid optoelectronic components and modules which can optically receive and transmit optical signals and have the ability to groom or decompose an optical signal into electronic signals.

111. A semiconductor waveguide optical regenerative device comprising:
an optical wave-guiding structure comprising a first input for receiving an input signal including a first wavelength component at a first wavelength, at least one input for local oscillator signal, and at least one output;
a ridge waveguide structure formed from molecular beam epitaxy deposition, metal oxide vapor beam epitaxy, chemical vapor deposition, lithography, etching or direct beam-direct write deposition.

112. A semiconductor waveguide optical regenerative device comprising:
an optical wave-guiding structure comprising a first input for receiving an input signal including a first wavelength component at a first wavelength, at least one input for local oscillator signal, and at least one output;
a ridge waveguide structure which can be used for optical signal regeneration.

113. A semiconductor waveguide optical regenerative device comprising:
an optical wave-guiding structure comprising a first input for receiving an input signal including a first wavelength component at a first wavelength, at least one input for local oscillator signal, and at least one output;
a ridge waveguide structure which can be used for pulse shaping.
